(19) United States
(12) Patent Application Publication
(10) Pub. No.: US 2022/0362934 A1
(43) Pub. Date: Nov. 17, 2022

(54) CONTROL DEVICE, CONTROL METHOD, AND PROGRAM

(71) Applicant: JOHNAN Corporation, Uji-shi, Kyoto (JP)

(72) Inventors: Kozo MORIYAMA, Uji-shi (JP); Shin KAMEYAMA, Uji-shi (JP); Truong Gia VU, Uji-shi (JP); Lucas BROOKS, Uji-shi (JP)

(73) Assignee: JOHNAN Corporation, Uji-shi, Kyoto (JP)

(21) Appl. No.: 17/761,566

(22) PCT Filed: Sep. 29, 2020
(86) PCT No.: PCT/JP2020/036824

§ 371 Date: Mar. 17, 2022

(30) Foreign Application Priority Data
Sep. 30, 2019 (JP) 2019-179128

(51) Int. Cl. B25J 9/16

(52) U.S. Cl. CPC B25J 9/1676

(57) ABSTRACT

A control device according to one or more embodiments may control a robot that performs a collaborative work with a worker. The control device may include: a storage section storing an operation program to cause the robot to perform the collaborative work with the worker; a control section controlling the robot based on the operation program when the collaborative work is performed; a calculation section calculating a motion of the worker when the collaborative work is performed; and a correction section correcting the operation program based on the motion of the worker calculated by the calculation section.

### TECHNICAL FIELD

The present invention relates to a control device, a control method and a program.

### BACKGROUND ART

Conventionally, a control device is known, which controls a robot that works together with a human worker (for example, see Patent Document 1).

A control device disclosed in Patent Document 1 is configured to estimate action of a worker based on image results taken by cameras, and thus to operate a robot according to the action of the worker. For example, when a unit is mounted on a target object, the unit is moved to a mounting position by the robot, and then, screws are fastened by the robot and the worker. Thus, the unit is attached to the target object. Subsequently, cables are placed at predetermined positions of the target object by the robot so that the worker receives the cables and connects them to the unit.

In the case where the worker enters the operation area or running area of the robot or the unit when the unit is moved to the mounting position by the robot, the robot is reduced in speed or stopped. In the same way, in the case where the worker enters the operation area or running area of the robot when the cables are moved to the predetermined positions by the robot, the robot is reduced in speed or stopped. Thus, it is possible to prevent the robot or the unit from colliding with the worker.

### PRIOR ART DOCUMENT

### Patent Document

[Patent Document 1] JP 2018-062016 A

### SUMMARY OF THE INVENTION

### Problem to Be Solved by the Invention

However, although the conventional control device as described above causes the robot to work in collaboration with the worker, the robot is controlled based on whether the worker enters the operation area or running area of the robot, and thus the operations of the worker are not sufficiently considered. Here, there is a room for improvement.

The present invention was made in consideration of the above circumstances, an object of which is to provide a control device, a control method and a program, which are capable of causing a robot to appropriately operate according to a worker when the robot works in collaboration with the worker.

### Means for Solving the Problem

A control device of the present invention is to control a robot that performs a collaborative work with a worker. The control device includes: a storage section storing an operation program to cause the robot to perform the collaborative work with the worker; a control section controlling the robot based on the operation program when the collaborative work is performed; a calculation section calculating a motion of the worker when the collaborative work is performed; and a correction section correcting the operation program based on the motion of the worker calculated by the calculation section.

With the above-described configuration, it is possible to cause the robot that performs the collaborative work with the worker to operate appropriately according to the worker by correcting the operation of the robot based on the motion of the worker.

A control method of the present invention is to control a robot performing a collaborative work with a worker. The method includes: a step of controlling the robot based on an operation program to cause the robot to perform the collaborative work with the worker; a step of calculating a motion of the worker when the collaborative work is performed; and a step of correcting the operation program based on the calculated motion of the worker.

A program of the present invention is to cause a computer to execute: a procedure to control a robot based on an operation program to cause the robot to perform a collaborative work with a worker; a procedure to calculate a motion of the worker when the collaborative work is performed; and a procedure to correct the operation program based on the calculated motion of the worker.

### Effects of the Invention

With the control device, the control method and the program of the present invention, it is possible to cause a robot to appropriately operate according to a worker when the robot performs the collaborative work with the worker.

### BRIEF DESCRIPTION OF THE DRAWINGS

FIG. 1 is a block diagram indicating a schematic configuration of a robot control system of an embodiment.

FIG. 2 is a flowchart indicating a procedure of operations of the robot control system according to the embodiment.

### MODE FOR CARRYING OUT THE INVENTION

Hereinafter, an embodiment of the present invention will be described.

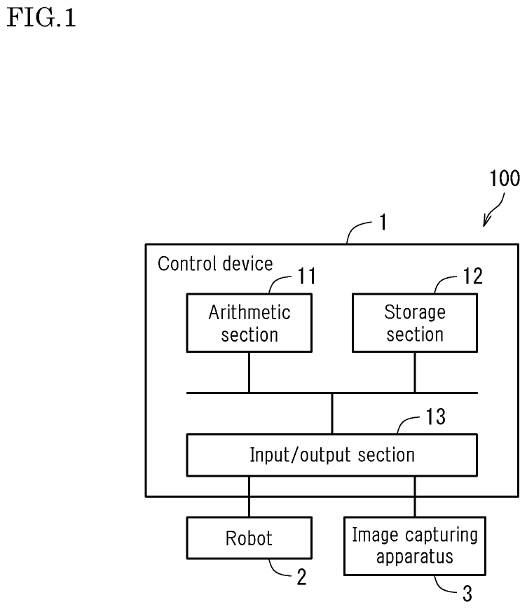

First, a description is given, referring to FIG. 1, on a configuration of a robot control system 100 including a control device 1 according to the embodiment of the present invention.

The robot control system 100 is introduced, for example, into a factory floor, and is configured to cause a robot 2 to execute operations in collaboration with a worker in the factory floor. In this robot control system 100, the robot 2 is not fenced so that a person can approach the robot 2. As shown in FIG. 1, the robot control system 100 includes: the control device 1; the robot 2; and an image capturing apparatus 3.

The control device 1 is configured to control the robot control system 100 including the robot 2. Specifically, the control device 1 causes the robot 2 to execute a collaborative work with the worker based on an image result taken by the image capturing apparatus 3.

The collaborative work is to be performed by the worker and the robot 2 in cooperation with each other, and includes the operation shared by the worker and the operation shared by the robot 2. As a specific example, the collaborative work includes: an operation by the robot 2 to pick a workpiece up from a first tray and to carry the workpiece in a predetermined position; an operation by the worker to process the workpiece at the predetermined position; and an operation by the robot 2 to carry the processed workpiece out and to place it on a second tray. The collaborative work is, for example, repeatedly performed.

The control device 1 includes: an arithmetic section 11; a storage section 12; and an input/output section 13. The arithmetic section 11 is configured to control the control device 1 by executing arithmetic processing based on a program and the like stored in the storage section 12. The storage section 12 stores an operation program and the like to control the robot 2. The operation program includes: a standard program to cause the robot 2 to perform the collaborative work with a worker; and adjustment data to adjust the standard program depending on the worker. The standard program is commonly used regardless of the workers while the adjustment data is set for every worker. That is to say, the storage section 12 stores the operation program for each worker. The input/output section 13 is connected to the robot 2 and the image capturing apparatus 3. Execution of the program stored in the storage section 12 by the arithmetic section 11 realizes the “control section”, the “calculation section” and the “correction section” of the present invention. The control device 1 is an example of the “computer” of the present invention.

The robot 2 is controlled by the control device 1 so as to perform the collaborative work with the worker. For example, the robot 2 has a multi-axis arm and a hand (as an end effector) provided at a tip of the multi-axis arm. The multi-axis arm is provided to move the hand, and the hand is provided to hold the workpiece.

The image capturing apparatus 3 is configured to take an image of a work area where the worker and the robot 2 perform the collaborative work. The work area is an area surrounding the worker and the robot 2 who work in collaboration with each other. Also, the work area includes an area through which the worker, the robot 2 and the workpiece pass when the collaborative work is performed. The image capturing apparatus 3 is provided so as to recognize the worker who works in collaboration with the robot 2 and also to calculate a motion of the worker at the time of the collaborative work. An image result of the image capturing apparatus 3 is output to the control device 1.

The control device 1 is configured to calculate the motion of the worker when the collaborative work is performed, and furthermore to correct, based on the calculation result, the operation of the robot 2 that performs the collaborative work. The calculation of the motion of the worker and the correction of the operation of the robot 2 are performed for every worker and every time when the collaborative work is performed. That is, the control device 1 is configured to learn the operation of the robot 2 that performs the collaborative work with the worker based on the motion of the worker when the collaborative work is performed.

Specifically, the control device 1 is configured to recognize the worker that works in collaboration with the robot 2 based on the image result of the image capturing apparatus 3. For example, the control device 1 detects the face of the worker based on the image result of the image capturing apparatus 3 and verifies the detection result with a face image database of the workers stored in the storage section 12. Thus, the control device 1 recognizes the worker. The storage section 12 stores an operation program for each worker who is registered in the database.

Then, when the control device 1 causes the robot 2 to work in collaboration with a determined worker by recognition, the control device 1 reads out the operation program for the determined worker so as to operate the robot 2 based on the operation program. The operation program for the determined worker includes: a standard program to cause the robot 2 to perform the standard operation (default operation); and adjustment data for the determined worker. The determined worker is a worker who performs the collaborative work with the robot 2, and is anyone of the workers, for example, registered in the database in the storage section 12.

Also, the control device 1 calculates the motion of the determined worker who performs the collaborative work based on the image result of the image capturing apparatus 3 at the time of the collaborative work. That is, the control device 1 calculates change in position (occupied space) of the determined worker over time during the collaborative work. Then, the control device 1 stores the calculated motion of the determined worker in the storage section 12. Thus, the control device 1 calculates adjustment data for the determined worker based on the motion of the determined worker, which is accumulated in the storage section 12. That is, every time the motion of the determined worker is calculated, the adjustment data for the determined worker is corrected.

The calculation of the motion of the determined worker as well as the correction of the adjustment data for the determined worker are performed every time when the collaborative work is performed by the determined worker and the robot 2. Since the motion of the determined worker at the time of the collaborative work is accumulated, the characteristics (tendency) of the motion of the determined worker become apparent. Thus, it is possible to appropriately adapt the operation of the robot 2 that performs the collaborative work to the determined worker by correcting the operation of the robot 2 according to the characteristics of the motion of the determined worker.

For example, according to the characteristics of the movement trajectory of the determined worker, the movement trajectory of the robot 2 is adjusted so as to avoid interference (collision) with the determined worker. Also, according to the characteristics of the movement speed of the determined worker, the movement speed of the robot 2 is adjusted so that the collaborative work goes smoothly.

### Operations of Robot Control System

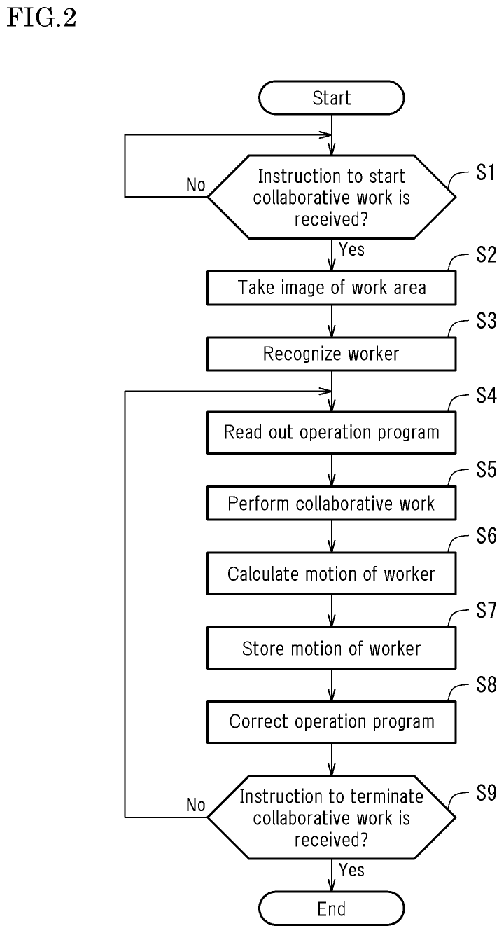

Next, a description is given, referring to FIG. 2, on the operations of the robot control system 100 according to this embodiment. The respective steps described below are executed by the control device 1.

In step S1 of FIG. 2, it is determined whether an instruction to start the collaborative work is received or not. When it is determined that the instruction to start the collaborative work is received, the procedure advances to step S2. On the other hand, when it is determined that the instruction to start the collaborative work is not received, the operation of step S1 is repeatedly performed. That is, the control device 1 is in a stand-by state until it receives the instruction to start the collaborative work.

Then, in step S2, taking an image of the work area of the collaborative work by the image capturing apparatus 3 is started. When a worker who performs the collaborative work enters the work area, an image of the worker is taken by the image capturing apparatus 3. The image result of the image capturing apparatus 3 is input to the control device 1.

Then, in step S3, the worker who performs the collaborative work is recognized based on the image result of the image capturing apparatus 3. For example, the face of the worker is detected from the image result of the image capturing apparatus 3, and the detection result is verified with the database in the storage section 12. Thus, the worker who performs the collaborative work is recognized.

Then, in step S4, the operation program for the determined worker thus recognized is read out. The operation program for the determined worker includes the standard program commonly used and the adjustment data for the determined worker, which is to cause the robot 2 to operate according to the determined worker at the time of the collaborative work.

Then, in step S5, the operation program for the determined worker is executed to cause the robot 2 to perform the collaborative work with the determined worker. The operation of the robot 2 that performs the collaborative work is adjusted, by the adjustment data for the determined worker, according to the characteristics of the motion of the determined worker. In other words, the operation of the robot 2 that performs the collaborative work is changed from the standard operation (default operation) as the robot 2 to the operation adapted to the determined worker. During the collaborative work with the determined worker and the robot 2, the image capturing apparatus 3 takes images of the work area and the determined worker who collaborates with the robot 2.

Then, in step S6 after the one cycle of the collaborative work is completed, the motion of the determined worker at the time of the collaborative work is calculated based on the image results of the image capturing apparatus 3 during the collaborative work. That is, the motion of the determined worker from the start of the one cycle of the collaborative work to the end thereof is calculated based on the image results of the image capturing apparatus 3.

Then, in step S7, the calculated motion of the determined worker is stored in the storage section 12. Thus, the storage section 12 accumulates motion history of the determined worker at the time of the collaborative work.

In step S8, the adjustment data for the determined worker is calculated and updated based on the motions of the determined worker accumulated in the storage section 12. That is, the adjustment data for the determined worker is corrected by the motion of the determined worker that is calculated in step S6. Thus, the operation program for the determined worker is corrected by the motion of the determined worker. In this way, since the operation program is corrected according to the characteristics of the motion of the determined worker, the operation of the robot 2 to be performed next time in collaboration with the determined worker is corrected.

In step S9, it is determined whether an instruction to terminate the collaborative work is received or not. When it is determined that the instruction to terminate the collaborative work is received, the robot 2 and the image capturing apparatus 3 are stopped, and the procedure advances to the “End”. On the other hand, when it is determined that the instruction to terminate the collaborative work is not received, the procedure returns to step S4, and thus the collaborative work is repeatedly performed.

### Effects

In this embodiment as described above, it is possible to cause the robot 2 to operate appropriately according to the determined worker by correcting the operation of the robot 2 to be performed next time in collaboration with the determined worker based on the motion of the determined worker when the collaborative work is performed. In this way, even when the worker who works in collaboration with the robot 2 is changed, it is possible to cause the robot 2 to operate appropriately according to the changed worker. Thus, since the robot 2 can be operated sufficiently taking into account the characteristics of the motion of the worker, it is possible to improve safety of the environment under which the worker and the robot 2 perform the collaborative work.

For example, according to the characteristics of the movement trajectory of the determined worker, the movement trajectory of the robot 2 is adjusted so that interference of the robot 2 with the determined worker is reduced. Thus, it is possible to prevent the robot 2 from interfering with the determined worker when the collaborative work is performed. Also, according to the characteristics of the movement speed of the determined worker, the movement speed of the robot 2 is adjusted so that the collaborative work goes smoothly. Thus, it is possible to smoothly perform the collaborative work, and thus to improve safety.

Also, when the work skill of the determined worker is improved and thus the work time shared by the determined worker in the collaborative work is shortened, the operation of the robot 2 at the time of the collaborative work with the determined worker is corrected according to the improvement of the work skill of the determined worker. Thus, the work time of the collaborative work can be shortened, which also contributes to reduction of unnecessary time wasting for the determined worker due to waiting for his/her turn in the collaborative work.

Also in this embodiment, it is possible to improve estimation accuracy of the characteristics of the motion of the determined worker by accumulating the motions of the determined worker.

### Other Embodiments

The foregoing embodiment is to be considered in all respects as illustrative and not limiting. The scope of the invention is indicated by the appended claims rather than by the foregoing description, and all modifications and changes that come within the meaning and range of equivalency of the claims are intended to be embraced therein.

For example, in the above-described embodiment, the robot transports the workpiece. However, the present invention is not limited thereto. The robot may process the workpiece. That is, although the robot 2 has the multi-axis arm and the hand in the above-described embodiment, the robot may have any configuration.

Also in the above-described embodiment, the worker is recognized by his/her face. However, the present invention is not limited thereto. The worker may be recognized by a card (not shown) carried by the worker.

Also in the above-described embodiment, the motion of the worker is calculated using the image capturing apparatus 3. However, the present invention is not limited thereto. The motion of the worker may be calculated using the image capturing apparatus and an event camera. Alternatively, the motion of the worker may be calculated using the image capturing apparatus and a radio-frequency sensor.

In the above-described embodiment, the adjustment data for the worker may also be corrected based on, in addition to the motion of the worker, the physical characteristics of the worker (for example, the height, the dominant hand, and the lengths of limbs).

Also in the above-described embodiment, outliers may be excluded from the past motions of the worker accumulated in the storage section 12. With this configuration, it is possible to further improve accuracy in estimation of the characteristics of the motion of the worker.

Also in the above-described embodiment, a warning may be issued when the calculated motion of the determined worker considerably differs from the characteristics of the past motions of the determined worker accumulated in the storage section 12.

Also in the above-described embodiment, the face of the worker is detected from the image result of the image capturing apparatus 3 so that the detection result is verified with the database. In the event that the detected worker does not correspond to anyone in the database, the worker may be registered in the database as a worker who performs the collaborative work for the first time. In this case where the worker performs the collaborative work for the first time, the robot 2 may perform the standard operation (default operation) by reading and executing the standard program in the operation program.

Also in the above-described embodiment, the worker is recognized so as to correct the operation program for each worker according to the motion of each worker. However, the present invention is not limited thereto. The worker is not necessarily required to be recognized. In this case, the common operation program for the workers may be corrected during performing the work based on the motion of the worker (specifically, chronological transition in position and posture in one operation, i.e. change of the space occupied by the body over time). For example, the operation program is corrected so as to optimize the action plan of the robot in order not to interfere with the motion of the worker. In other words, depending on the motion of the worker at the time of the collaborative work, the subsequent motion of the robot in the collaborative work is immediately corrected. Specifically, step S3 and S7 in the flowchart in FIG. 2 may be omitted, and the calculation of the motion of the worker and the correction of the operation program may be repeatedly performed at the time of the collaborative work.

Also in the above-described embodiment, the operation speed of the robot may be adjusted according to the operation speed of the worker. For example, according to the operation speed of the worker in charge of respective operation steps, the operation processing speed of the robot through the entire steps may be adjusted.

Also in the above-described embodiment, when the robot performs the collaborative work with the determined worker, the operation program for the determined worker him/herself is used. However, the present invention is not limited thereto. An operation program for a worker other than the determined worker may be used at the time of the collaborative work with the determined worker. For example, it is possible to cause the robot to operate based on the operation program for the worker selected as the worker with optimal work efficiency in the group of the workers having similar physical characteristics, as a result of the comparison of the motions of the respective workers. In this case, since the worker should match the movement of the robot, it is possible to improve the work skill of the worker.

### INDUSTRIAL APPLICABILITY

The present invention is suitably applied to a control device, a control method and a program, which control a robot that works in collaboration with a worker.

### DESCRIPTION OF REFERENCE NUMERALS

1 Control device (computer)

2 Robot

3 Image capturing apparatus

11 Arithmetic section

12 Storage section

13 Input/output section

100 Robot control system

1. A control device for controlling a robot to perform a collaborative work with a worker, comprising:
a storage section storing an operation program to cause the robot to perform the collaborative work with the worker;
a control section that controls the robot based on the operation program when the collaborative work is performed;
a calculation section that calculates a motion of the worker when the collaborative work is performed; and
a correction section that corrects the operation program based on the motion of the worker calculated by the calculation section.

2. A control method for controlling a robot to perform a collaborative work with a worker, comprising:
controlling the robot based on an operation program to cause the robot to perform the collaborative work with the worker;
calculating a motion of the worker when the collaborative work is performed; and
correcting the operation program based on the calculated motion of the worker.

3. A non-transitory computer-readable medium storing a program, which when read and executed causes a computer to perform operations comprising:
controlling a robot based on an operation program to cause the robot to perform a collaborative work with a worker;
calculating a motion of the worker when the collaborative work is performed; and
correcting the operation program based on the calculated motion of the worker.
